(19) United States
(12) Patent Application Publication
(10) Pub. No.: US 2010/0031175 A1
(43) Pub. Date: Feb. 4, 2010

(54) Computerized method for relating variables in user-defined equations to dimensions on digital drawings

(76) Inventor: Michael Lee Kijewski, Phoenixville, PA (US)

Correspondence Address: Michael Lee Kijewski, 986 Spring City Rd., Phoenixville, PA, 19460, US

(21) Appl. No.: 12/462,467

(22) Filed: Aug. 4, 2009

Related U.S. Application Data
(60) Provisional application No. 61/137,808, filed on Aug. 4, 2008.

(51) Int. Cl. G06F 7/38; G06F 3/048

(52) U.S. Cl. 715/764; 708/200

(57) ABSTRACT

A computerized method that allows users to relate variables in mathematical equations that they define to dimensions on a digital drawing file that they import. The results of these equations are calculated and displayed both graphically and numerically. Multiple equations can be evaluated simultaneously, and the user may quickly switch between graphical and numerical views of the results of many different equations.

This patent application is the patent application for provisional patent application No. 61/137,808, dated Aug. 4, 2008, confirmation number 1459. This provisional patent application was filed by Michael Lee Kijewski. The title is “GrayCAD radiation shielding analysis software.”

### BACKGROUND

This invention relates to the practice of performing mathematical calculations based on the dimensions of a digital drawing in two or three dimensions. If one wanted to calculate, say, the inverse square of the distance between all points on a two dimensional surface and an origin point, one would need to divide the two dimensional surface into a large finite number of points and perform the calculation for each point.

Various software applications exist that allow a user to either a) determine the distance between points on a digital drawing or b) perform a series of calculations and return the results in an array. No single application currently exists that allows a user to create variables from dimensions in a drawing file, use those variables in a user-defined mathematical expression, and return the results in a graphical and numerical format The present invention provides the user a single application in which to perform these operations.

### SUMMARY OF THE INVENTION

A first aspect of the present invention provides a method for users to import an existing digital image file. The user will scale the image file, using a known dimension in the drawing. For example, the user may import a plan view architectural drawing of a building. The user would then highlight a known dimension on the drawing and enter the value of this dimension into the software. This allows the software to determine accurate distances on the drawing according to the scale set by the user.

A further aspect of the present invention allows the user to create mathematical variables in the software that can relate to equations that the user will define later. For example, the user may want to define the variable “a” as the distance between two points on the drawing. The user can later use this variable in one or more equations that he will define.

User can define an equation, using a combination of user-defined constants, and values of variables obtained from the drawing, and have the software calculate the results of these equations

A further aspect of the present invention provides a method for users to define a custom equation in the software that the software will later calculate and display the results of both graphically and numerically. The user can use any combination of variables defined by the user, standard variables the software automatically makes available, and numbers. The invention may allow the user to use a variety of mathematical functions in their equation.

A further aspect of the present invention provides a method for providing the results of the computation of the users' equations in both a graphical format and a numerical, tabular format For example, the software may return the value of the square root of the distance between all points in the drawing and a user-defined origin as a “temperature map” overlay on the imported drawing, with different colors assigned to different number ranges. Also, the user may select a number of “survey points” for which the numerical results of the calculations that have been performed in a tabular format

### DETAIL DESCRIPTION

The present invention provides a method for users to relate the variables in various user-defined equations to the dimensions of a digital drawing provided by the user. A computer application allows a user to import a digital drawing file, define variables in mathematical equations to dimensions on the drawing file, define the equations the user wishes to evaluate, and present the results of the equation both graphically and numerically.

The user will import a digital drawing file in one of many filetypes. These files may be in pdf, jpg, bmp, tiff, dwf, dwg, on one of many other digital image file formats. Once the file is imported, the user will scale the drawing using a scaling caliper. The user will place the ends of the caliper around a line on the drawing of a known dimension. Once the caliper ends are in place, the user enters the scaled distance between the ends of the caliper into the software.

The user then defines lines in the drawing that will serve as variables in future mathematical expressions. For example, if a user wishes to import a drawing of a building floor plan, and use the distance between two walls in a room as a variable, the user would draw a line between the two walls in question, and give that dimension a name. The scaled length of this line will be available for use in future mathematical equations.

The application will allow users to define values of other variables using a table format. For example, if a user wants to define a variable called “Pi,” they would enter both the name of the variable and the value of the variable in an input table. This value would then be available for use in later user-defined equations.

The present invention will allow a user to define a mathematical equation, the results of which will be output in graphical and numerical formats. The user opens a window into which a mathematical expression is typed. This expression may be typed using a variety of math typesetting languages, such as MathML, LaTeX, or similar. Multiple equations can be entered, which are stored as separate “layers.”

The results of the mathematical expressions entered by the user are presented in both graphical and tabular numerical formats. A color overlay with colors representing numerical ranges(temperature map) can be superimposed over the drawing. Additionally, lines with dimensions equal to the results of the equations can be drawn overtop of the drawing. Also, a table showing the equation number, all involved variables, and the results of the equation calculation can be displayed, and exported in various formats. These formats may include csv, text, rtf, or one of many other formats.

Multiple drawings can be related to the same project. Tabs appear above the drawing display window, allowing the user to quickly switch between different drawings relating to the same project

### DETAILED DESCRIPTION OF DRAWINGS

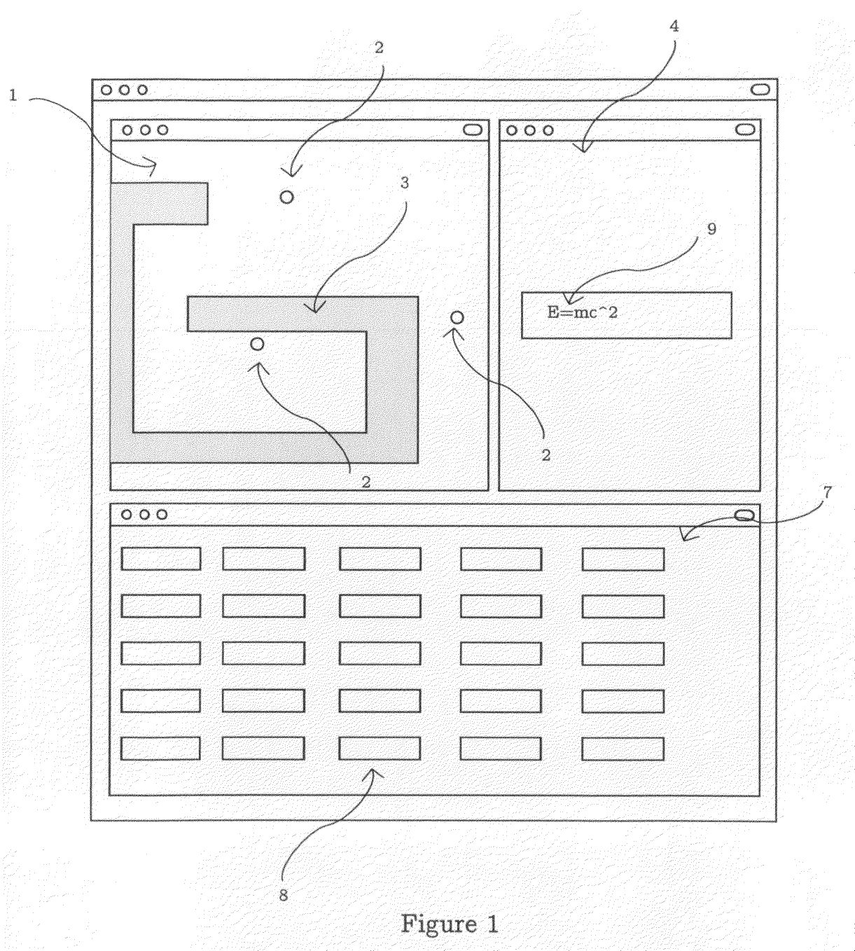

FIG. 1

FIG. 1 shows the three main window panes of the invention. A window allows the user to interface with the digital drawing that has been imported (1). The user can specify an origin point (2), as well as multiple evalation points (2). The user can also specify regions of the drawing that pertain to the equations being employed (3). The user can define and edit equations to be used in this window (9). Another window allows the user to interface with the mathematical algorithms that the user wishes to be employed in this particular project (4). Another window allows the user to see a quick view of the input and output variables (8) of the equations being evaluated in the drawing (7).

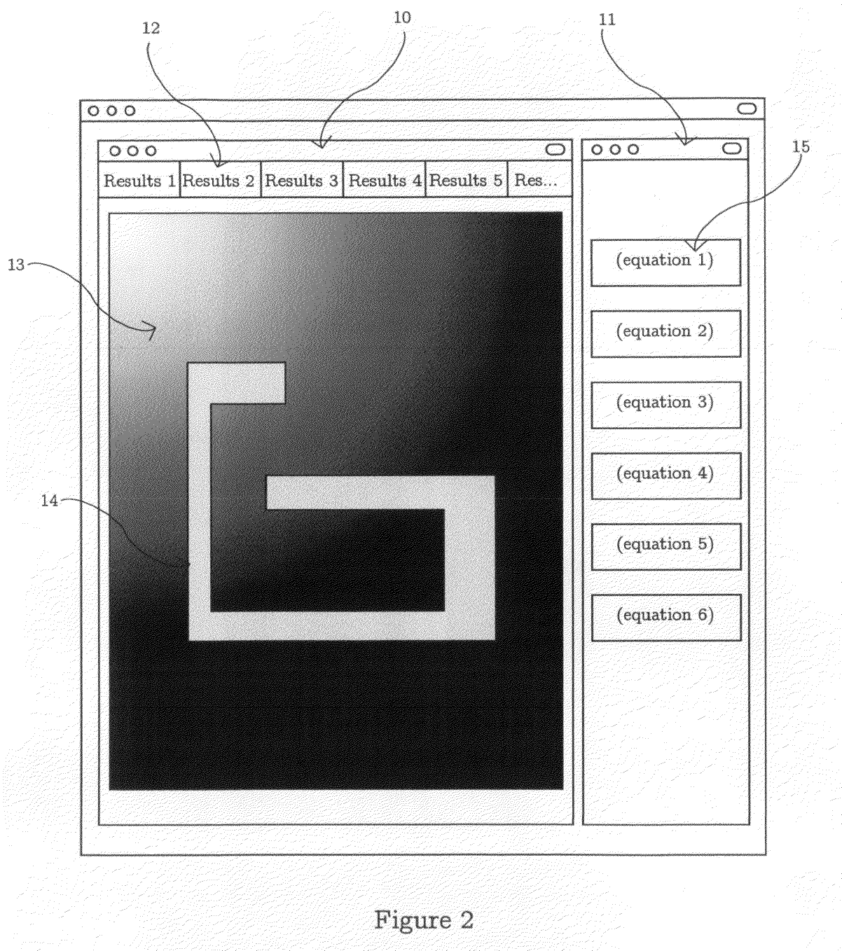

FIG. 2

FIG. 2 shows two window panes of the invention that allow the user to evaluate a graphical representation of the numerical results of the equations being evaluated. A window shows the user a graphical representation of the numerical results of the equations being evaluated (10). This graphical representation may be in the form of a “temperature map,” where different colors relate to different number ranges (13). This graphical representation may also be in the form of lines with specific dimensions relating to the results of the equations being evaluated (14). Buttons along the top of this window allow the user to quickly switch between graphical representations of the results of several different mathematical algorithms (12). Another window allows the user to edit the equations being evaluated (11). The user may have the ability to edit several different equations (15), the results of which are being shown in a different window.

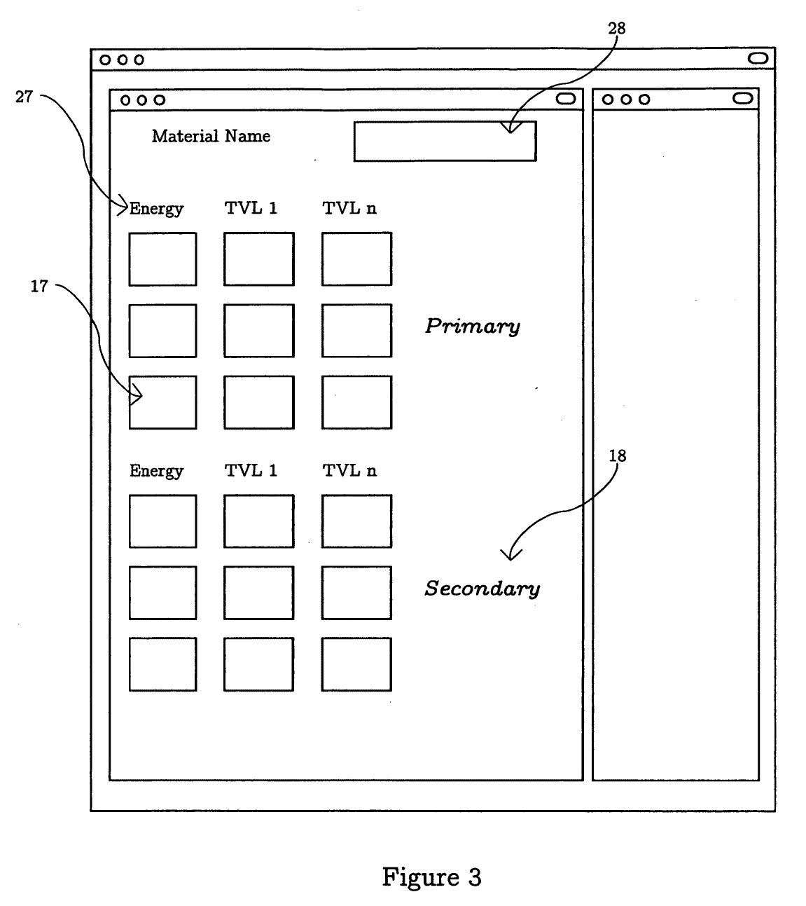

FIG. 3

FIG. 3 shows a window of the invention that allows the user to define numerical values of variables that will be available for use in other windows of the invention, such as the equation editor window. The user can enter custom numerical values (17), and compile these variables into sets (28). The user can create multiple sets of these values.

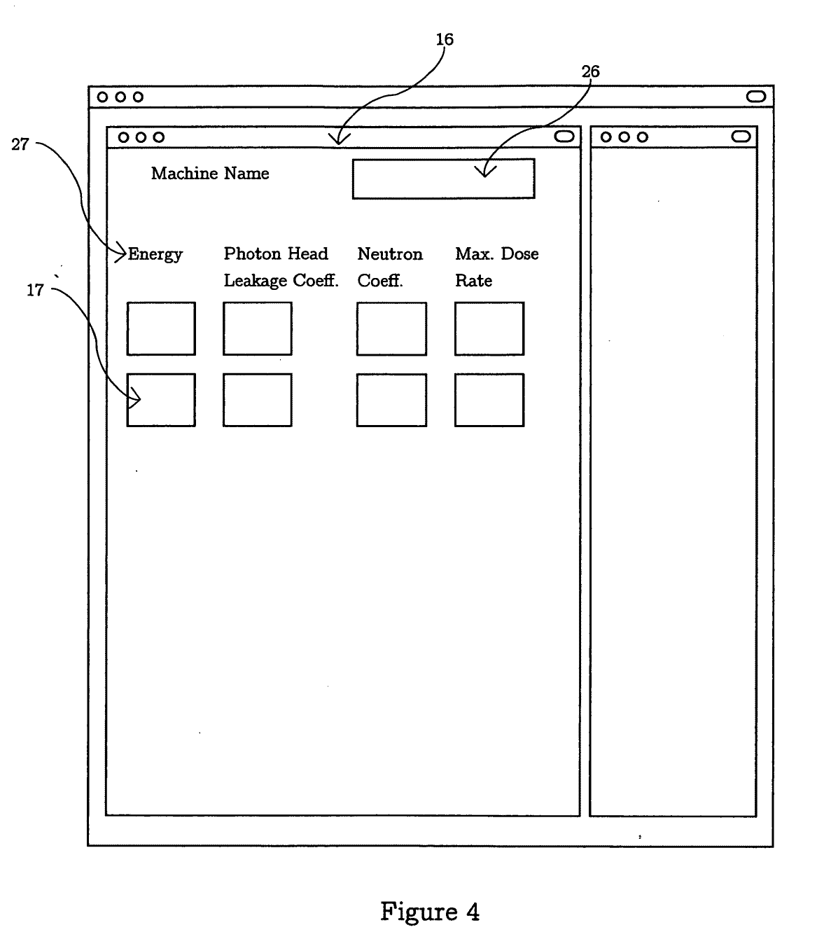

FIG. 4

FIG. 4 shows a window of the invention (16) that allows the user to define numerical variables of variables that will be available for use in other windows of the invention, such as the equation editor window. The user can enter custom numerical values (17), and save these values as a set (26).

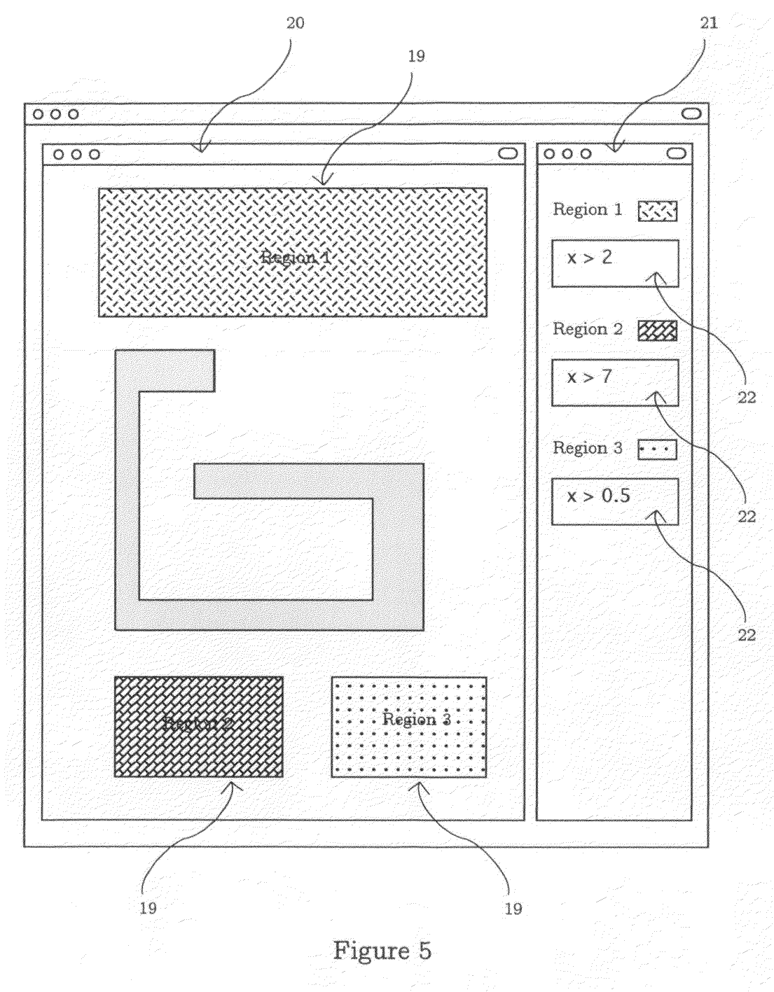

FIG. 5

FIG. 5 shows windows of the invention that allow the user to define zones of the digital drawing, and apply particular parameters to these zones. One window (20) allows the user to click and draw a region on the drawing, and label this region (19). Another window (21) allows the user to define numerical parameters that should be observed in this drawing (22.) The user may define a maximum value of a particular equation result (22.) The user will be alerted if the evaluation of a particular equation results in a value that is outside of the range specified by the user. The user may also define the value of a particular variable that will be used in the equations being evaluated.

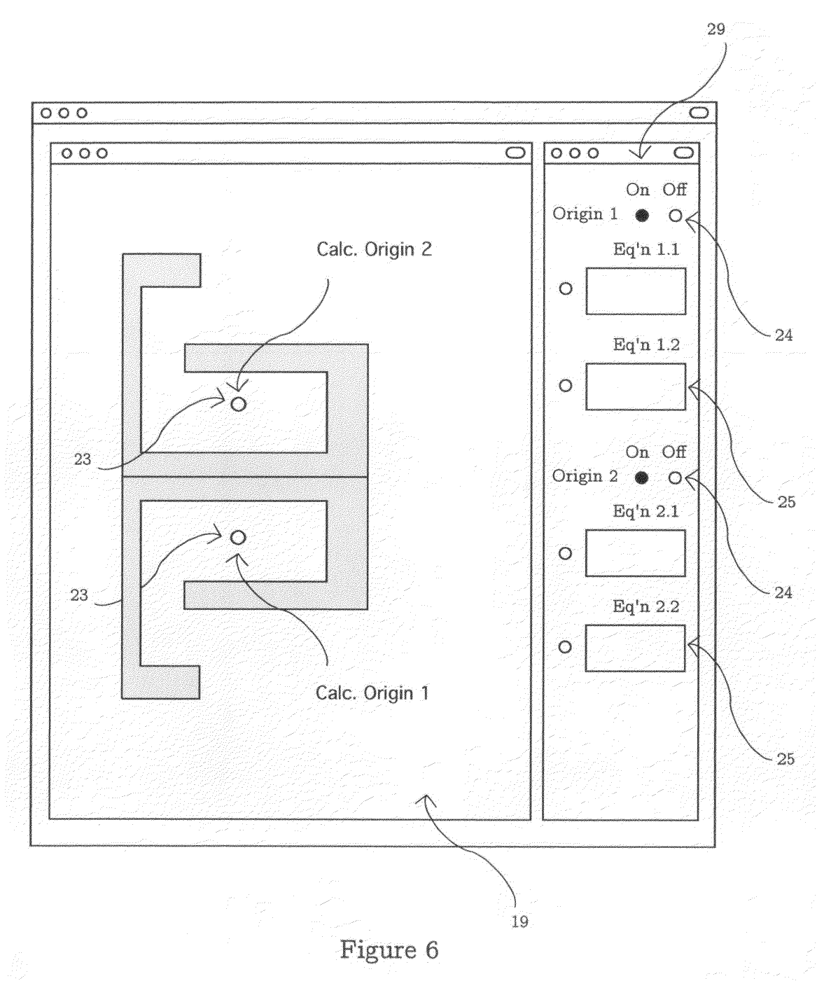

FIG. 6

FIG. 6 shows two windows of the invention that allow the user to define specific parameters of multiple equations. In one window (19), the user may set multiple calculation origins (23). These origins-may be assigned to one or more equation in a separate window (29). In this separate window (29), the user may specify which point each equation should use as the origin (24). Multiple equations may use the same origin point (25).

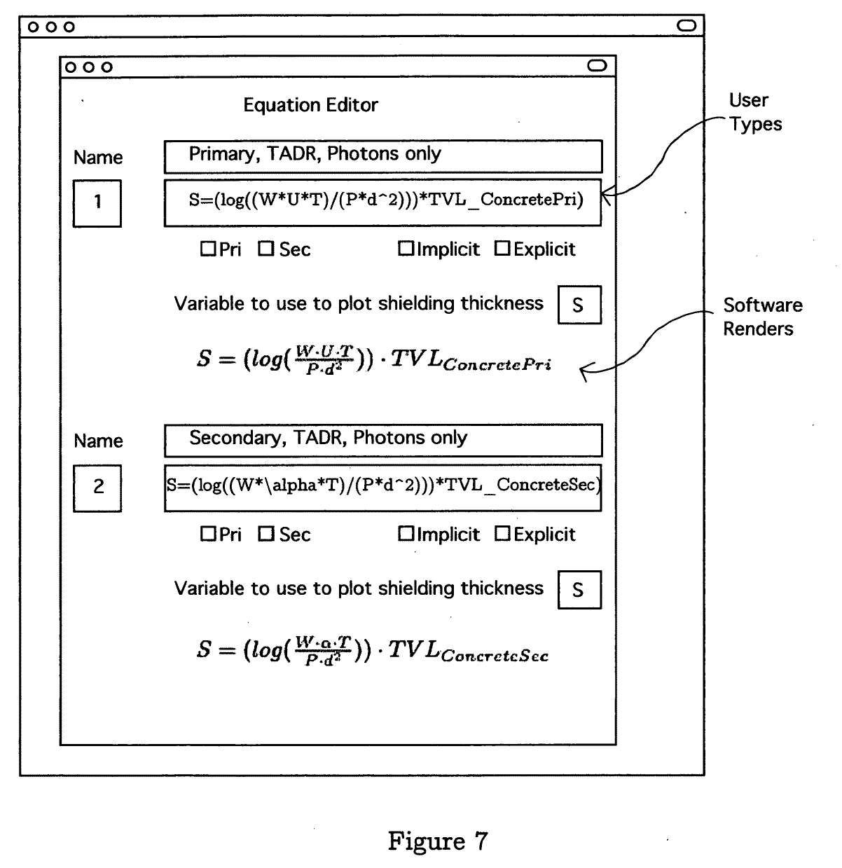

FIG. 7

FIG. 7 shows a window of the invention that allows the user to define custom mathematical algorithms to be plotted in the drawing. The user may type the mathematical equation, give it a name, and specify which variable in the equaton should be plotted as the result. The invention is able to plot a variable that is solved for explicitly, as well as implicitly. For example, the user may choose to plot the value of “P” in equation 1 as the equation result, given that the user specifies values for all other required variables.

What is claimed is:

1. A computer method for relating variables in mathematical equations to dimensions in digital drawings of geometric objects.

2. A method for creating mathematical variables from geometric dimensions of digital drawing of claim 1

3. A method for applying mathematical algorithms to the variables of claim 2.

4. A computer program product allowing a user to import the drawing of claim 1 in various digital image formats, define the variables of claim 2 using click and point tools, and display the results of the algorithm of claim 3 in numerical or graphical formats

5. A computer application that manages multiple calculation algorithms of claim 3 and their respective results described in claim 4, allowing a user to quickly compare visual representations of different algorithms

6. A computer application that allows users to specify value ranges of mathematical algorithm results for particular regions of a drawing of claim 1 that alert the user of an algorithm resulting in a numerical result higher than the alarm value specified by the user
